(19) United States
(12) Patent Application Publication
(10) Pub. No.: US 2007/0055911 A1
(43) Pub. Date: Mar. 8, 2007

(54) A Method and System for Automatically Generating a Test-Case

(76) Inventors: Harald Boehm, Schoenaich (DE); Erwin Pfeffer, Halzgerlingen (DE); Joerg Walter, Tuebingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/460,365

(22) Filed: Jul. 27, 2006

(30) Foreign Application Priority Data
Sep. 2, 2005 (EP) 05108046.3

(51) Int. Cl. G06F 11/00

(52) U.S. Cl. 714/31

(57) ABSTRACT

The present invention relates to an automated method and system for transforming a hardware test-case within a system level into at least one unit test-case for a functional unit within a unit level, wherein the functional unit is a component of said hardware. The method comprises the steps of emulating a model of the hardware in the system level, applying the hardware test-case for the system level, recognizing and selecting an information relevant for the functional unit, transforming the information into commands for the functional unit and outputting the unit test-case for the functional unit.

### BACKGROUND OF THE INVENTION

1. Field of the invention

The present invention relates to a method and system for automatically generating a hardware test-case. In particular, the invention relates to a method and system for automatically transforming a processor test-case into at least one unit test-case for a functional unit, wherein the functional unit is a component of said processor.

2. Description of the Related Art

Typically, a test-case includes a sequence of instructions, commands and/or operations applied to the device under test and/or under verification. The sequence of instructions may be generated by deterministic or random methods. Said deterministic methods provide a predetermined set of inputs and a description of the expected responses for the device under verification. Said random methods generate a sequence of random commands for the device under verification and provide checker programs for monitoring the outputs of the devices under test for their correctness. Deterministic methods have the inherent problem that it is difficult to create a large number of different test-cases.

For complex systems to be tested, test-case generators are often used that automatically create a large number of random test-cases from architectural level descriptions of the system in order to ensure sufficient test coverage. Such a test-case generator for the architecture verification provides random sequences of instructions with the expected results to specified interfaces. The U.S. Pat. No. 6,148,277 describes an example of such a test-case generator.

These architecture verification test-case generators can be used for a broad range of variations of the system architecture. For example, they can be used for subsequent generations of the same basic hardware architecture and even for more or less similar architectures; see e.g. B. Wile et al. “Functional verification of the CMOS S/390 Parallel Enterprise Server G4 system”, IBM J. Res. & Dev., vol. 41, No. 4/5, 1997, where the application of the AVPGEN test-case generator is described for the verification of a generation of an IBM S/390 processor.

In order reduce the complexity, larger systems are developed by splitting the system into smaller components or units. These units are developed and verified separately before they are aggregated and combined into the large system, which is then itself verified. However, for arbitrary system units, i.e. a functional unit of a processor, randomly generated unit-level test-cases are often created automatically by generators that need to be developed specially for said components. The uniqueness of the different units prevents the use of a general test-case generator at the unit-level.

For example, in conventional development processes the verification of a complete processor and the verification of single processor components, e.g. functional units, are separated and independent proceedings.

The randomly generated unit-level test-cases using conventional methods are very suitable to find design errors in situations, which the designer or engineer did not think of. On the other hand the randomly generated unit-level test-cases may describe a situation, which never occurs in a real system. This problem could be avoided by taking the system architecture into account for the generation of unit test-cases.

However, it requires a lot of effort to manually create test-cases that are derived from the system architecture. Therefore sufficient test coverage for the unit is unlikely using manually created unit test-cases. An automated method for the creation of unit-level test-cases that are derived from the system architecture would solve this problem.

### OBJECT OF THE INVENTION

It is therefore an object of the present invention to provide a method and system for the automated creation of system unit test-cases that is improved over the prior art.

### SUMMARY OF THE INVENTION

The above object is achieved by a method as laid out in the independent claims. Further advantageous embodiments of the present invention are described in the dependent claims and are taught in the description below.

The core idea of the invention is a mechanism to transform a system level test-case into one or more lower level test-cases for a specific unit of the system. The system level may relate to a processor and the lower level to a unit of the processor. During the execution of the test-case, a system emulator extracts information, which is only relevant for the specific component of said system.

In the preferred embodiment of the invention test-cases for processor units are condensed test-cases derived from an instruction stream for the processor, which are randomly generated by an architectural verification test-case generator. Therefore the test-cases cover only operations, which may occur in the processor.

Further advantageous embodiments of the present invention are described in the dependent claims and are taught in the description below.

### BRIEF DESCRIPTION OF THE DRAWINGS

The above as well as additional objectives, features and advantages of the present invention will be apparent in the following detailed written description.

The novel and inventive features believed characteristics of the invention are set forth in the appended claims. The invention itself, their preferred embodiments and advantages thereof will be best understood by reference to the following detailed description of preferred embodiments in conjunction with the accompanied drawings, wherein:

FIG. 1 shows a schematic diagram of a method and system according to the present invention,

FIG. 2 shows a more detailed diagram of the method and system according to the present invention, and

FIG. 3 shows a schematic diagram of a verification environment for the method and system according to the present invention.

### DETAILED DESCRIPTION OF THE INVENTION

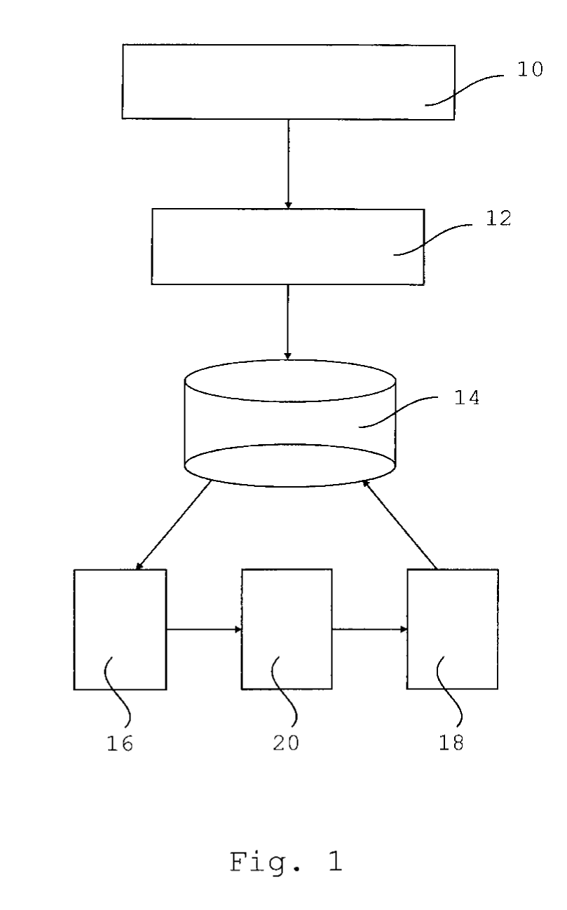

FIG. 1 shows a schematic diagram of a preferred embodiment of the method and the system according to the present invention for the verification of a processor and its functional units. The processor architecture is implemented by hardware circuits and special firmware code called millicode. An example for such a processor is the processor of the IBM zSeries 990; see L. C. Heller et al. “Millicode in an IBM zseries processor”, IBM J. Res. Dev., Vol. 48, No. 3/4, 2004.

The system comprises a processor test-case 10, a millicode emulator 12 and a XL library 14. The processor test-case 10, the millicode emulator 12 and the XL library 14 are within an architecture level. The processor test-case 10 consists of processor instructions. The millicode emulator 12 is a software simulator that can process millicode directly. The XL library 14 contains so-called XL files. Further the system comprises a first software component 16, a second software component 18 and a processor unit 20 within an implementation level.

In the preferred embodiment of the present invention the processor test-case 10 is an architecture verification program (AVP) with one or more AVP-files. An example for the AVP is the AVPGEN program for the IBM S/390 and zseries processors. In the preferred embodiment the processor architecture is the instruction set architecture of the processor.

The architecture verification programs (AVPs) are provided for higher-level verifications, ranging from chip simulation to system simulation. The AVP itself is not suited for the simulation of a single unit, because the AVP is a generic test-case, which requires all the units of the processor. The AVP do not put enough stress to the unit under verification. Further multiple levels of caches reduce the stress to the peripheral units of the processor.

In a conventional method the processor test-case 10 is used to test the entire processor, wherein the processor test-case 10 is directly applied to the processor or a corresponding simulation model. In said conventional method the processor test-case 10 is loaded in a memory and then executed in simulation by clocking the processor. If the results received from the simulation do not match the predicted output results, the simulation stops and an error is flagged.

In the inventive method only the processor unit 20 is under verification. The processor unit 20 cannot handle the processor test-case 10. Therefore the additional components are required. According to the invention the millicode emulator 12 is used to execute the processor test-case 10. Further the millicode emulator 12 is used to extract information relevant to the processor unit 20. The millicode emulator 12 behaves substantially like a processor. The millicode emulator 12 loads and executes the processor test-case 10. The processor test-case 10 includes specifications of the registers, a specification of the memory contents and the storage keys and an instruction stream. The registers and the memory are given before and after the execution of the instructions. The processor instructions are translated into operation codes for the processor unit 20. The memory data, which are required for the operation of the unit under verification, are extracted. The unnecessary register data are filtered out by the millicode emulator 12, since not all register data are available in the processor unit 20.

An example of a processor unit is the address translation unit. The millicode emulator 12 has to execute the address translation sequence exactly as it would happen in the hardware. For any operation an instruction fetch is done to a current instruction pointer address. After setting up the registers required performing the translation, the virtual address is sent together with additional control signals in a fetch type command to the design under verification.

It is advantageous, that the processor test-case 10 is based on the instruction set architecture, which is relatively stable between various generations or models of the same processor. At least the instruction set architecture provides a backward compatibility. Therefore the processor test-case 10 may be re-used between different projects. As an output format for the millicode emulator 12 a unit specific language is defined, which provides said backward compatibility between the different projects. The actual driving and/or checking of the interface are done by a specific runtime library.

The split between the test-case contents at the architecture level has the further advantage, that the test-case does not need to be regenerated, when the implementation of the unit changes. For example, the implementation may be changed, if the interface signals change. Such interface changes can be required during the development of the processor due to inconsistencies in the specification or the implementation that were discovered during the development. Such interface changes are also usual between various models and generations of the processor. Therefore the method of the present invention combines the advantages of the architecture level test-case specification on the one hand and of the unit simulation by using the runtime library on the other hand.

Further the application of the inventive method saves time, since the reference model for the processor unit 20 is contained in the processor test-case 10. A separate reference model is not necessary for the processor unit 20.

The inventive method allows the use of the processor test-case 10 at a very early development stage, where the entire processor is not available.

The inventive method may be used for the verification of processor units that contain interfaces such as registers that are specified by the instruction set architecture. Examples are a floating point unit or an address translation unit; a cache unit however is transparent for programs executed on the processor and therefore not part of the instruction set architecture.

An address translator converts virtual addresses used by applications into absolute addresses used to access to the main memory. The most complex part of the simulation environment for the translator unit is the calculation of the translation results for all different address modes. For example, an IBM S/390 or zseries processor provides a 24 bit, a 31 bit or a 64 bit addressing.

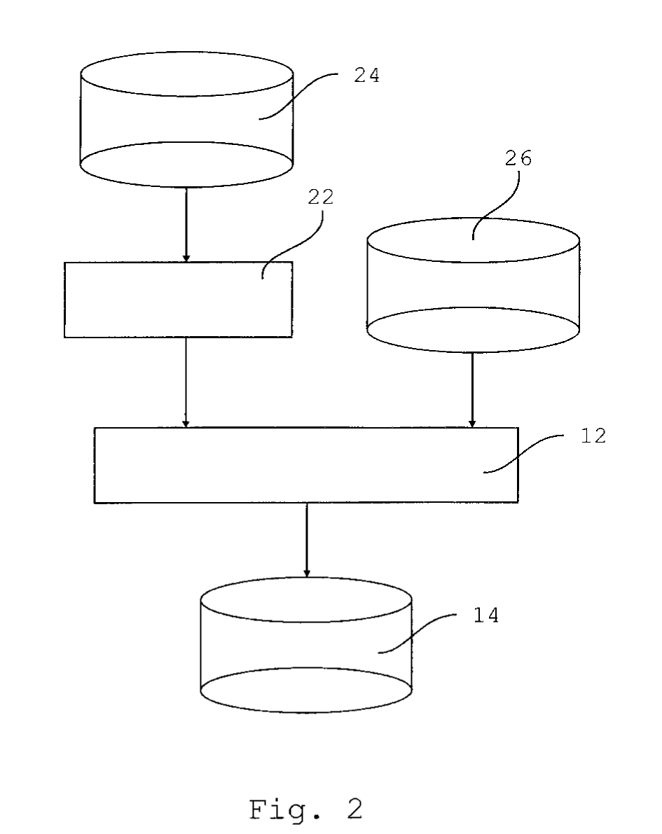

FIG. 2 shows a detailed schematic diagram of the test-case generation by the method according to the present invention. In this example the system includes the millicode emulator 12 and the XL library 14. Further this example comprises an AVP generator 22, a SIG library 24 and an AVP library 26. The SIG library 24 contains symbolic instruction graphs, which are used as an input for the AVP generator 22. The symbolic instruction graph specifies the instructions to be used for the instruction stream in the test-case. The symbolic instruction graphs may be generated by the verification engineer. Further any existing symbolic instruction graph may be used for the test-case generation. Many different test-cases may be derived from a single symbolic instruction graph.

The AVP generator 22 generates random instruction streams used for the late stage verification. For example, the AVP generator 22 may generate random instruction streams for a processor. The AVP generator 22 generates the processor test-cases 101 which are stored in the AVP library 26. The AVP library 26 contains also processor test-cases from previous projects. The processor test-cases 10 are executed on the millicode emulator 12.

Normally the millicode emulator 12 is used to debug the millicode of the processor. The millicode emulator 12 is an existing building block, which is otherwise used to verify the millicode. In this embodiment the millicode emulator 12 is modified to generate an output file, the translator test-case. The translator test-case contains all information relating to the translation process, i.e. the translation requests and the expected translation results for the random instruction stream in the program test-case 10. The resulting translator files are stored in the XL library 14. The XL library 14 may also contain hand written translator files.

The structure of a translator test-case is defined by a YACC grammar. The YACC grammar describes a simple translator language providing syntactic elements for all possible translator operations. The syntactic elements correspond to the facilities and operation codes of the address translator. Therefore the address translator is very easy to use. The translator test-case may have the form shown in the following table.

| | |
|---|---|
| STATUS | <register_data> |
| ... | |
| INPUT | |
| Command | <command> |
| VirtAddr | <virtual_address> |
| [MemData | <command>] |
| ... | |
| RESULT | |
| AbsAddr | <absolute_address> |

The translator test-case includes three sections, namely a STATUS section, an INPUT section and a RESULT section.

The STATUS section contains statements to set up the control registers of the translator. Any other statements are not allowed in the STATUS section, so that the syntax simply consists of the register address followed by the register data.

In the INPUT section the command to the translator is specified. Further the virtual address to be translated and the translation parameters are specified in the INPUT section. If a table lookup is required, a MemData statement contains the lookup address expected to send by the translator and the data, which should be returned as a result back to the translator. Depending on the specified translation operation, multiple MemData statements may be required.

The RESULT section contains the kind of the expected result. For example the result may be an absolute address Other results may be exceptions or none at all, if the translator just propagates a message to another unit.

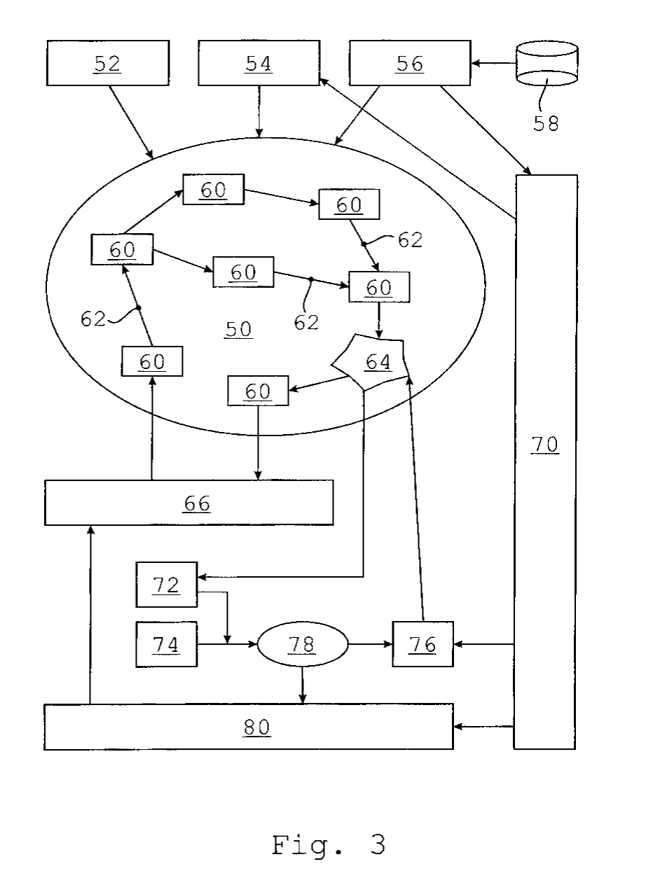

FIG. 3 shows a schematic diagram of a verification environment, which may use the method according to the present invention. In this example the verification environment is provided for an address translator. Every test-case generated by the inventive method may be executed as a data flow graph (DFG) 50 within this verification environment.

In FIG. 3 the verification environment comprises one data flow graph 50. Additionally the verification environment may comprise further parallel data flow graphs 50, which are not represented in FIG. 3. The data flow graph 50 includes a plurality of nodes 60 and a plurality of arcs 62 connecting the nodes 60. The arcs 62 are unidirectional. In this example the nodes 60 and the arcs 62 form substantially a loop, which is connected with a DFG execution engine 66. The nodes 60, the arcs 62 and the DFG execution engine 66 form a closed token ring. However, it is not necessary, that the data flow graph 50 forms a loop. The connection between the data flow graph 50 and the DFG execution engine 66 basically works in such a way, that the DFG execution engine 66 is able to call all nodes 60, which are in an active state. The DFG execution engine 66 may handle a token passing between the nodes 60, in order to determine, which nodes 60 are in an active state. The DFG execution engine 66 makes a note of the active nodes 60 and is able to call them. Thus the DFG execution engine 66 has a connection to all nodes 60.

Every node 60 of the data flow graph 50 may be connected with port drivers and/or interface monitors. For example, in FIG. 1 the node 64 is connected with the port driver 72 and the interface monitor 76 for output events. An example with two nodes 60 includes the following steps: A first node 60 sends a request to the device to be tested by transferring a corresponding data package to the port driver 72. At this time the first node 60 is active. After that, the first node 60 is deactivated and a token is send to a second node 60 via the DFG execution engine 66. Then, the second node 60 is activated. The second node 60 checks the response of the device via the interface monitor 76 for output events, if the response is correct. After that, the second node 60 terminates the procedure.

Further the verification environment comprises three generators, namely a hard coded generator 52, a random generator 54 and a deterministic test-case generator 56. The hard coded generator 52, the random generator 54 and the deterministic test-case generator 56 feed the data flow graph 50 and the DFG execution engine 66. The hard coded generator 52 creates fixed sequences required for DUV (design under verification) operations, e.g. a firmware load sequence. Such a fixed sequence DFG is usually activated upon certain events in the DUV, e.g. reset or recovery operations.

The random generator 54 creates random data flow graphs 50 during the runtime of the simulation. The deterministic test-case generator 56 creates deterministic data flow graphs 50 at the startup time of the simulation. A specification file 58 feeds the deterministic test-case generator 56.

Additionally the environment provides means for creating manually the data flow chart 50.

The verification environment comprises further a reference model 70, an interface monitor 74 for input events, a design under test (DUT) 78 and an unit monitor 80. The reference model 70 receives information from the deterministic test-case generator 56 and sends information to the interface monitor 76 for output events and to the unit monitor 80. The DUT 78 is connected between the port driver 72, the interface monitor 74 for input events and the interface monitor 76 for output events and provides the unit monitor 80 with information.

Within the data flow graph 50 one or more data flow graphs may be specified. The data flow graphs include a plurality of nodes 60 and a plurality of arcs 62 connecting the nodes 60. The test-cases are mapped as sequences of the instructions and/or operations into the data flow graph 50. The data flow graph 50 may be changed and/or extended dynamically.

The environment may have several data flow graphs 50. The different generators 52, 54 and/or 56 may feed the different data flow graphs 50 in order to execute different test-cases. This allows a parallel execution of random and deterministic test-cases.

Each node 60 in the data flow graph represents an instruction or an operation for the device under verification. The arcs 62 between the nodes 60 of the data flow graph describe the structure of the test-case. The inputs of the device are stimulated by software generators 52, 54 and/or 56 within the verification environment. The information stored in the active nodes 60 of the data flow graphs is used.

An arbitrary number of data flow graphs may be active in parallel within the verification environment. The data flow graph may be generated at the simulation startup time by the deterministic test-case generator 56. Further sequences of instructions and/or operations may be irritated by random events, e.g. interrupts or exceptions. This allows different timing and execution conditions for the same sequence on every time.

The main data flow propagates through the DFG execution engine 66. The active nodes 60 are determined by the DFG execution engine 66 via tokens, which propagate through the data flow graph. Whenever a node 60 is complete it passes on a token to the next node 60.

The data flow graph 50 and the DFG execution engine 66 are generic and independent of the device. On the other hand, the generators 52, 54 and 56 of the test-cases and the port driver 72 depend on the device under verification.

In the preferred embodiment of the invention a translator test-case file is mapped to a data flow graph 50 in a way that every statement in the test-case file is mapped into a node 60. This mapping can be performed by the deterministic test-case generator 56. For example, a MemData statement would be mapped to a node 64 that instructs the corresponding port driver 72 to send out a table lookup request using the table address given in the MemData statement. When the interface monitor 76 receives the response for the table lookup request, it forwards the received data to the node 64. The node 64 will then compare the received data to the table data as specified in the MemData statement. If the comparison is successful, the node 64 sends out a token to flag the completion of its node action. An error is flagged otherwise.

A data flow graph 50 represents the architectural level of the test-case, whereas the port driver 72 and the interface monitors 74 and 76 represent the implementation level.

Instead of mapping every statement of the translator test-case into a node 60, it is also possible to map several statements at once into a node 60, e.g. mapping a complete address translation into a node 60. On the other hand it is also possible to distribute selected statements to several nodes 60, e.g. mapping the MemData statement to two or more nodes 60. This allows to better control parallel events, but increases the control overhead for the nodes 60.

The present invention can also be embedded in a computer program product, which comprises all the features enabling the implementation of the methods described herein. Further, when loaded in a computer system, said computer program product is able to carry out these methods.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 processor test-case
12 millicode emulator
14 XL-library
16 first software component
18 second software component
20 processor unit
22 AVP generator
24 SIG library
26 AVP library
50 data flow graph
52 hard coded generator
54 random generator
56 deterministic test-case generator
58 specification file
60 node
62 arc
64 node
66 DFG execution engine
70 reference model
72 port driver
74 interface monitor for input events
76 interface monitor for output events
78 design under test
80 unit monitor

1. A method for automatically generating a test-case for a specified functional unit within a hardware system, comprising the steps of:
a) emulating the hardware system;
b) applying a hardware test-case to the emulated hardware system;
c) extracting from the results of the hardware test case information relevant for the functional unit;
d) transforming the extracted information into commands for the functional unit; and
e) outputting the commands as a unit test-case for the functional unit.

2. The method according to claim 1, wherein the hardware comprises registers and memory components and the step c) comprises the steps of:
c1) recognizing and selecting the specification of the registers in the hardware test-case relevant for the functional unit; and
c2) recognizing and selecting the specification of the memory contents in the hardware test-case relevant for the functional unit.

3. The method according to claim 1, wherein the step d) comprises the steps of:
d1) translating instructions of the hardware test-case into operation instructions for the functional unit; and
d2) extracting memory data required for the operation of the functional unit.

4. The method according to claim 1, wherein the method comprises the further step of filtering out register data from the hardware test-case, which register data are not available in the functional unit.

5. The method according to claim 1, wherein the format of the test-case for the functional unit is independent from the implementation.

6. A system comprising means adapted to perform the method according to claim 1.

7. The system according to claim 6, wherein the hardware in the system level comprises a processor.

8. The system according to claim 6, wherein the system comprises a millicode emulator for executing a processor test-case.

9. The system according to claim 6, wherein the millicode emulator is provided for extracting the information relevant for the functional unit.

10. The system according to claim, wherein the millicode emulator is provided for filtering out the register data from the hardware test-case, which register data are not available in the functional unit.

11. The system according to claim 6, wherein the millicode emulator is provided for extracting memory data required for the operation of the functional unit.

12. The system according to claim 11, wherein the functional unit is a component of the processor.

13. A computer program loadable into the internal memory of a digital computer system and comprising software code portions for performing the method according to claim 1 when said program is run on said computer.

14. A computer program product comprising a computer usable medium embodying program instructions executable by a computer, said embodied program instructions comprising means to implement the method according to claim 1.
